(19) United States
(12) Patent Application Publication
(10) Pub. No.: US 2022/0030778 A1
(43) Pub. Date: Feb. 3, 2022

(54) STORMWATER PLANTER SYSTEM

(71) Applicant: MMT, INC. DBA STORMTREE, Pawtucket, RI (US)

(72) Inventor: Paul Anthony IORIO, Pawtucket, RI (US)

(21) Appl. No.: 17/280,539

(22) PCT Filed: Sep. 26, 2019
(86) PCT No.: PCT/US2019/053161

§ 371 Date: Mar. 26, 2021

Related U.S. Application Data
(60) Provisional application No. 62/736,868, filed on Sep. 26, 2018.
(60) Provisional application No. 62/905,870, filed on Sep. 25, 2019.

(51) Int. Cl. A01G 9/02; A01G 27/02; E03F 1/00

(52) U.S. Cl. CPC A01G 9/02; E03F 1/005; A01G 27/02

(57) ABSTRACT

A stormwater planter system containing plant material being comprised of a container fabricated of concrete, metal, plastic, or the like, that captures surface rainwater runoff or roof rainwater runoff whereby debris, sands, sediment, pollutants within the water are separated, treated and/or attenuated via multiple processes within a predetermined organic and/or non-organic aggregate material layer. The water is then discharged from the container either through internal pipe, or by direct infiltration into the subsurface environment. More particularly, the system incorporates features and structures to enable ease of maintenance, and healthier plant growth without competition from weeds and other non-desirable plant material.

This application claims priority to and the benefit of U.S. Provisional Patent Application No. 62/736,868 filed Sep. 26, 2018, the entire contents of each are incorporated by reference herein.

### FIELD OF THE OF THE INVENTION

The application relates generally to a stormwater planter system and a method to promote the healthy development of newly planted vegetation. The design of the system and method would allow for the capture of rainwater and surface runoff from adjoining impervious surfaces, adjacent buildings, and the like. Features to allow for unrestricted plant growth and the prevention of competition from weeds and alien plants, as well as ease of maintenance, are also incorporated in the system design.

### BACKGROUND OF THE INVENTION

Low impact development (LID) is a term used to describe a land planning and engineering design approach to managing stormwater runoff. LID emphasizes conservation and use of on-site natural features to protect water quality. This approach implements engineered small-scale hydrologic controls to replicate or mimic the pre-development hydrologic regime of watersheds through infiltrating, filtering, storing, evaporating, and detaining runoff close to its source. A concept that began in Prince George's County, Maryland in approximately 1990, LID began as an alternative to traditional control measures. Officials found that traditional practices of detention and retention system maintenance were not cost-effective, and in many cases, the results did not meet water quality goals. LID stormwater management systems were shown to reduce development costs through the reduction or elimination of conventional stormwater conveyance and collection systems. Furthermore, LID systems may reduce the need for paving, curb and gutter replacement, piping, inlet structures, and stormwater ponds by treating water at its source instead of at the end of the pipe. Although up-front costs for LID practices are generally higher than traditional controls, developers often recoup these expenditures in the form of enhanced home and community marketability, and higher lot yields. Developers are not the only parties to benefit from the use of LID stormwater management techniques. Municipalities also benefit in the long term through reduced maintenance costs.

The term “best management practice” (BMP) is used to collectively identify various stormwater control practices and methodologies to treat water at its source instead of through an engineered subsurface drainage system. Of particular interest in regard to the present invention, is a BMP practice based on the principals of “bioretention.” Bioretention is typically defined as the filtering of stormwater runoff through a plant/soil/microbe complex to capture, remove, and cycle pollutants by a variety of physical, chemical, and biological processes. Bioretention is a practice that relies on gravity to allow stormwater to infiltrate though natural or engineered soil (media) complexes while providing some degree of sediment collection/separation and encouraging microbial degradation of entrained pollutants.

Bioretention practices including rain gardens, sand filters, and stormwater planters began to be incorporated as part of LID practices beginning in the 1990′s. The ability and rate of hydraulic transport is essentially unencumbered by structural components or barriers whether introduced or previously existing, but more a feature of geologic composition. Although sand filters provide some degree of bioretention efficacy, more importantly, rain gardens and stormwater planters rely on plant systems to further enhance microbial activity, and assimilate and uptake pollutant constituents, while providing aesthetic appeal. Accumulated test data of pollutant removal rates by bioretention practices has consistency shown high levels of remediation. Bioretention practices rely on “direct infiltration” as the primary mechanism to achieve stormwater transport as well as pollutant removal efficiencies. Direct infiltration allows for the vertical movement of water through gravity or hydraulic head. Most federal and state environmental protection agencies recognize direct infiltration as the preferred means for returning rainwater runoff to the natural aquifer system as opposed to piping collected stormwater to a downgradient waterbody location potentially miles away such as a river, lake, or the ocean.

Rain gardens are non-structured systems, meaning that they do not rely on a constructed or fabricated container to provide functionality. Rain gardens are typically formed out of natural low points or depressions in landscaped areas or excavated by hand or machine. These depressions serve as collection points for stormwater runoff. Following excavation, existing soils, particularly if they are determined to have low infiltrating capacity, can be augmented with sand or other coarser grained aggregates to improve infiltration. Alternatively, an engineered media, specifically designed for rain gardens or other applications where efficient infiltration is desired may be used. Shrubs, perennials, and/or grasses are then planted in the media, and serve to provide a conduit for infiltrating water, as well as providing aesthetics. The surface of a rain garden is typically that of exposed soil/media or covered with a layer of organic mulch material. This surface permits infiltration to occur, while the plantings mirror that of a landscaped garden to blend with the natural environment. Since rain gardens are constructed in vegetated areas, and are formed in earth depressions, they are not typically located in heavily paved or impervious environments.

Although highly effective in providing stormwater management when functioning as designed, a well understood limitation to rain gardens as described here is the maintenance burden and upkeep necessary for continued efficiency. Since the rain garden's surface is typically exposed soil/media, or mulch covered, over time, weeds and other alien plant material may germinate and invade the space. If left unchecked, these invaders may takeover and ultimately choke out the resident plants and reduce overall infiltration capacity. Additional limitations with rain gardens are the importation and surface settlement of fine sediments which are transported with incoming rainwater, as well as the accumulation of fallen leaves and dead plant material which can adhere to the soil and/or mulch surface. The increased deposition of these materials, over time, can create a confining layer which can greatly reduce the infiltration and operating capacity of the system. Time consuming and costly manual maintenance must then be employed to revitalize and return these systems to full function. If the rain garden(s) are in the realm of the public sector, then the maintenance burden falls on the municipality. Public works departments typically rely on the use of machinery and mechanical equipment to provide efficiency of services as cost effectively as possible. Due to its simple design and structure, rain garden maintenance requires manual labor, mainly by rake and shovel which is inefficient and costly.

Stormwater planters, unlike rain gardens, are constructed or fabricated structures designed to contain and process incoming stormwater runoff while providing bioretention efficiencies. They are best suited for primarily impervious areas such as sidewalks, plazas, and parking lots where natural infiltration is limited. In practice, stormwater planters function similarly as rain gardens, providing the same bioretention functionality—they could be described as “urban” rain gardens. However, various constructed stormwater planter systems that are currently in the public domain do not appear to address the aforementioned fundamental deficiencies inherent with rain gardens.

Several advantages to the present invention as to be detailed in the following description are designed to rectify the perceived deficiencies in current stormwater planter systems, particularly in highly impervious areas. Some of these advantages include healthier plant growth with less competition from weeds; debris and sand capture; and, flexibility in design and configuration. These and other advantages will become apparent from a consideration of the following description and accompanying drawings.

### BRIEF SUMMARY OF THE INVENTION

The present invention is a stormwater planter system designed to efficiently collect stormwater runoff and provide for healthy plant growth and reduced maintenance requirements. Primary consideration has been given to enhancing the growth and health of plant material by incorporating supporting features and structures to reduce competition from weeds and alien plant material, which in turn, would also drastically reduce or eliminate the burden of weeding, and increase the appealing aesthetics of the planter system. Much consideration has also been given to providing a primary chamber that is separate from the main chamber being divided by a semi-impermeable wall. This primary chamber would provide the benefit of storing and gradually dispensing water through the semi-impermeable wall to the plant material in the main compartment long after the initial precipitation event has occurred thus providing supplemental irrigation during periods of drought. This chamber would also have the added benefit of segregating incoming sand, sediments, and debris from the primary chamber, thereby extending the intended operating efficiencies of the system, while reducing the maintenance burden. One of several embodiments of the present invention may incorporate internal piping to collect and/or discharge incoming water to the subsurface environment exterior of the structure.

The system is envisioned to be constructed in one of two ways:
(1) a substantially water impermeable treatment container with enclosed sidewalls, and a defining bottom surface which prevents or reduces the ability to infiltrate treated stormwater into the subsurface environment;
(2) an open bottomed, and/or primarily open sided container, allowing for direct infiltration of treated water into the subsurface environment.

Both constructed systems would be primarily open on the top surface to allow for the growth and access of plant material from the surface.

### BRIEF DESCRIPTION OF THE DRAWINGS

FIG. 1 is a cutaway cross sectional view of a stormwater planter system of the present invention;

FIG. 2 is a plan view of a stormwater planter system of the present invention;

FIG. 3A, 3B are a cutaway cross sectional view and a plan view respectively of an embodiment of the present invention;

FIG. 4A, 4B are a cutaway cross sectional view and a plan view respectively of a second embodiment of the present invention;

FIG. 5 is a cutaway cross sectional view of a third embodiment of the present invention;

FIG. 6 is a cutaway cross sectional view of a fourth embodiment of the present invention;

FIG. 7 is cutaway cross sectional view of a fifth embodiment of the present invention;

FIG. 8A, 8B are a plan view and a cross sectional view respectively of a sixth embodiment of the present invention; and

FIG. 9 is a plan view of a seventh embodiment of the present invention.

These renderings and images are included for illustrative and interpretive purposes relative to specific embodiments and applications and should not be construed as the sole positioning, configurations, or singular use of the present invention.

### DETAILED DESCRIPTION OF THE INVENTION

The following detailed description of the invention reference is made to the accompanying drawings which form a part hereof, and in which are shown, by way of illustration, specific embodiments in which the invention may be practiced. These embodiments are described in sufficient detail to enable those skilled in the art to practice the invention. Other embodiments may be utilized, and structural and logical changes may be made, without departing from the scope of the present invention.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, ‘or’ refers to an inclusive or and not to an exclusive or. For example, a condition A or B is satisfied by any one of the following: A is true (or present) and B is false (or not present), A is false (or not present) and B is true (or present), and both A and B are true (or present). Also, use of the “a” or “an” are employed to describe elements and components of the invention. This is done merely for convenience and to give a general sense of the invention. This description should be read to include one or at least one and the singular also includes the plural unless it is obvious that it is meant otherwise. Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting. In the following description, numerous specific details are provided, such as the identification of various system components, to provide an understanding of embodiments of the invention. One skilled in the art will recognize, however, that embodiments of the invention can be practiced without one or more of the specific details, or with other methods, components, materials, etc. In still other instances, well-known structures, materials, or operations are not shown or described in detail to avoid obscuring aspects of various embodiments of the invention. Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “and/or” as used herein is defined as the possibility of having one or the other or both. For example, “A and/or B” provides for the scenarios of having just A or just B or a combination of A and B. If the claim reads A and/or B and/or C, the composition may include A alone, B alone, C alone, A and B but not C, B and C but not A, A and C but not B or all three A, B and C as components.

“Impermeable subsurface membrane liner” as used herein, refers to a synthetic, flexible material which acts as a barrier to separate and maintain segregation between two discrete layers of inorganic and/or organic materials thus preventing the infiltration of water between the two layers.

“Collar” as used herein, is a flat rim or flange of various dimension on a surface object serving to define or form an opening or entry way to allow an object to effectively pass through from one side to the other such as water passing through an opening in the base of an otherwise closed bottom sink or basin.

“Enhanced material” as used herein, is any product or substance that serves to better or improve an expected consequence, such as fertilizer to a plant.

“Paved” as used herein, to cover a ground surface with a hard material such as concrete or asphalt suitable for traffic.

“Surface entry” as used herein, the point or moment where a plane or upper boundary such as a paved surface makes contact with the top surface of a receiving facility such as a container, whereby water is transported from the paved surface into the receiving facility.

Reference throughout this specification to “plant(s)”, “vegetation”, or “roots” is used. “Vegetation” as used herein, is a collective term for a living and growing organism of the kind exemplified by trees, shrubs, vegetables, ornamental flowering plants, herbs, grasses, ferns, and mosses, and the like, typically growing in a permanent site, absorbing water, oxygen, and nutrients through its roots. One skilled in the art will recognize that embodiments of the invention should not be limited to these terms and that the terms herein are interchangeable or in general association for any tree, plant, root, or other vegetation that would benefit from the described invention.

“Root controlling mechanisms” are features of an item that forces the roots of vegetation to grow in a desired manner.

“Semi-impermeable subsurface membrane liner” as used herein, refers to a synthetic, flexible material which acts as a porous barrier to separate and maintain segregation between two discrete layers of inorganic and/or organic materials thus allowing for the controlled flow of water between the two layers.

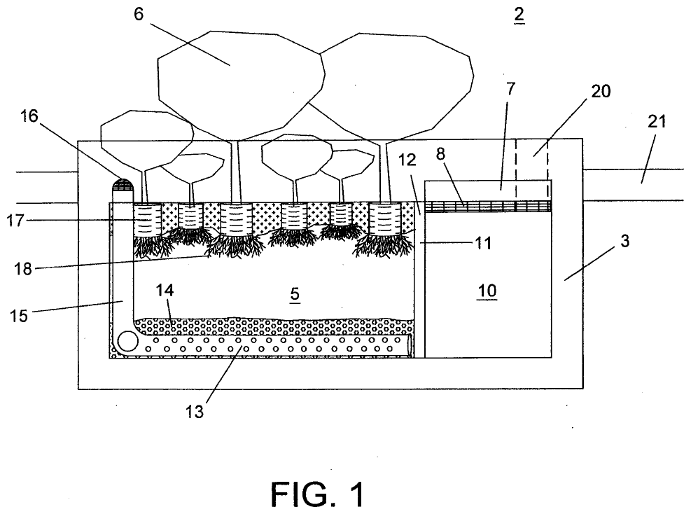

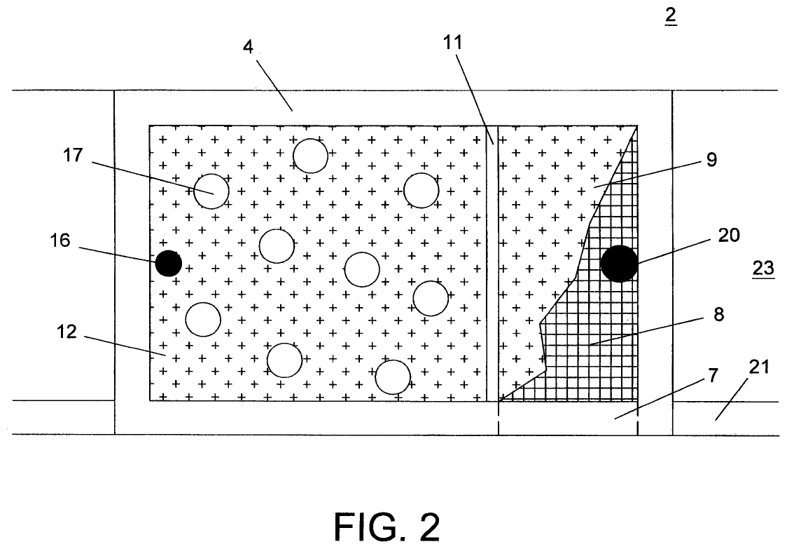

Referring now to the invention in more detail, in FIG. 1 and FIG. 2, there is a stormwater planter system 2 comprised of a closed bottom (although it should be appreciated that a partial bottom wall is possible) container with four vertical sidewalls 3 (although in some embodiments only three walls are required) of varying dimension creating an interior space, with a top portion 4 primarily open to the atmosphere. In some embodiments, one or more sidewalls may extend upward from 0 to 36 inches above the ground and/or may have a length from about 2 to about 15 feet. The container maintains two or more discrete layers of media 5 comprised of organic (with or without trace amounts of inorganic material) or inorganic (with or without trace amounts of organic material) materials, or a mixture thereof In the preferred embodiment, two discrete layers of media, one comprised primarily of inorganic material is positioned atop a discrete layer of primarily organic material, are found within the interior of the system. In further detail, still referring to the invention in FIG. 1 and FIG. 2, water enters the container via an opening 7 or “throat” (or window, baffle or aperture) located on a side of the container and then contacts a perforated screen or grate 8 which may or may not have a defined superficial layer of inorganic and/or organic aggregate material 9 overlying the grate. The water will permeate one or more layers and further enter a closed bottom “pretreatment” compartment 10, i.e. a sump having at least three vertical walls and a bottom wall that may abut the system, i.e. shares a vertical wall with the system, and is separated from the organic and/or non-organic materials portion of the container by an impermeable or semi-impermeable, fixed or moveable flat panel or baffle wall 11. The fixed or moveable flat panel or baffle wall 11 may be manufactured from concrete, plastic, fiberglass, metal or combinations thereof. As water continues to enter the pretreatment compartment, the water level will rise to a point whereby it will spill over the top of the wall and then enter the organic and/or non-organic materials portion 5 of the container. Sand, sediment and large objects may settle to the bottom of the sump and may be removed therefrom periodically. The flat panel or baffle wall allows for the flow of water between the interior of the planter system and the interior of the sump. The flat panel or baffle wall allows for the flow of water collected in said sump into the interior of the planter system when needed to irrigate the vegetation within the planter system or for the flow of excess water from the interior of the planter to the sump to prevent the pooling of water in the interior of the planter system. In other embodiments, the sump does not abut a wall of the planter system and may be connected to same by a remote feed, i.e., a conduit, more likely, a non-rusting, non-corroding pipe. A perforated screen or grate situated above or below the surface of water, i.e. stormwater entering the planter system, may cover the opening of the sump preventing objects and debris from entering the interior of the sump. The perforated screen or grate may be manufactured from any durable materials, preferably, plastic, metal, fiberglass or a composite thereof. A superficial layer of inorganic, organic or a mixture of inorganic and organic aggregate material may overlay the grate or perforated screen.

An embodiment would be an underlying perforated collection and drainage pipe 13 located substantially within or in contact with an aggregate layer 14 within the container that would capture and transfer collected water to a location outside of the container. In one embodiment, the perforated pipe extends from one vertical sidewall, through the interior space o the system and partially exits the opposing sidewall. An additional embodiment would be a perforated or unperforated vertical pipe 15 with cover or removable cap 16 connected to the underlying collection and drain pipe within the container to capture and evacuate accumulating water which rises above the top surface of the organic and non-organic materials layer within the top portion of the container. The vertical pipe 15 extends through the grate and into the interior of the sump wherein the end of the pipe located in the sump may be closed. In another embodiment, the grate or screen covering the sump may contain an opening. Both the vertical pipe 15 and the opening in the grate are capable of allowing an evacuation means into the sump to allow a user to evacuate debris or other undesirable articles accumulated at the bottom of the sump. Both the vertical pipe 15 and the opening in the grate may comprise means, such as a gasket or collar, in which to create an air tight seal when the evacuation means, i.e., a vacuum hose in inserted into either. The cover or removable cap 16 may be configured with a locking means in which to prevent the unwanted entry into the interior of the sump via the vertical pipe 15. The vertical 15 or evacuation pipe may be manufactured from any durable material, preferably, plastic, metal, fiberglass, a composite thereof and any combination thereof

In other examples, a second a vertical pipe wherein said vertical pipe connected to the horizontal water collection and drainage pipe captures and evacuates accumulating water rising above the top surface of the organic and inorganic materials layers contained in the planter system. This vertical pipe may include a covering to prevent debris from entering said pipe. This covering may be a screen or grate, more particularly, an atrium or basket grate.

In some embodiments, one or more water ingress pipes or conduits located in one or more vertical sidewalls allow for the direct flow of water originating from a point exterior to and/or above said system into the interior of the planter system, such as the roof of a building, one or more gutters of a building or any other overhead structure, or the interior of the sump. The water ingress pipes or conduits are relatively horizontal to the planter system (and/or the aggregate layer contained therein) and are situated above or below ground at predetermined elevations relative to the planter system. The water ingress pipes may be connected to one or more a series of additional pipes which carry water from another source to the water ingress pipes. The water ingress pipes may be perforated wherein said perforations are located in one or more sections of a water ingress pipe that is in direct communication with the interior of the planter system or the interior of the sump. The water ingress pipe may be manufactured from any material, preferably, plastic, metal, fiberglass, a composite thereof or any combination thereof.

The planter system may further comprise a perforated screen or grate with a defined superficial layer of inorganic, organic or a mixture of organic and inorganic aggregate material situated above and/or on said perforated screen or grate situated in such a way that when said water enters the planter system through said throat or aperture said water encounters said perforated screen or grate.

Plant material 6 is envisioned to be placed and growing within a solid or perforated, primarily open top, i.e. proximal end and open bottom, i.e. distal end, tubular cylinder (socket) 17 of various length and width, fabricated of metal, plastic, liquid silicone rubber, fiberglass, combinations of the aforementioned or any other sufficiently flexible material. Different types of plastic, such as poly(methyl methacrylate), polycarbonate, high-density polyethylene, acrylic-polyvinyl chloride, acrylonitrile butadiene styrene and any combinations thereof may be used and if metal is selected, aluminum is preferred. The sockets are made from one or more sheets of material having distal and proximal edges, preferably from one sheet and may be solid or may contain a multitude of perforations. To form the sockets, the flexible sheet of material is rolled until the distal edge of the flexible sheet of material is situated underneath the proximal edge of the sheet of material until the desired cylindrical shape is achieved. It is important to form the socket so that it is capable of expanding, preferably up to twice its initial size or greater, thereby increasing the size of its interior as needed. The roots 18 of the plant material would be expected to primarily grow out through the bottom of the socket into the nutrient-enriched material area. In another embodiment, the sockets have an initial width of 6±5% inches that can expand up to and including 12±5% inches, has an initial width of 10±5% inches that can expand up to and including 20±5% inches or an initial width of 18±5% inches that can expand up to and including 36±5% inches. In other examples, the sockets have a length of 4±5% inches to 16±5% inches. The sockets may be pre-filled with nutrient-rich soil and/or moisture retaining material and/or time-release fertilizer to support the growth of vegetation.

An embodiment of the present invention would be a defined layer of a primarily inorganic aggregate material comprised of sand, gravel, stone, rubber, plastic, silica, glass beads, ceramics, shale, clay, activated alumina, activated iron, activated plant-based carbon material, reconstituted rock or the like and any combination thereof (and in some embodiments an additive comprised of iron or aluminum oxide, an expanded ceramic, or a water treatment residual no greater than 20% (±5%) by volume or any combination thereof) 12 surrounding the socket(s) to a level at or near the established vertical top surface of materials within the container. In some embodiments, the sockets extend from at or above the surface of the inorganic layer, through said inorganic layer, and into said organic layer, said organic layer with trace amounts of inorganic material or said mixed organic/inorganic layer.

An embodiment would be that an opening 20 of a defined dimension would be formed on the top surface of the screen or grate to allow access to the pretreatment compartment from a position above the container. The top surface of the container in FIGS. 1 and 2 is envisioned to be raised and located at an elevation above its surrounding surface. The construction details of the invention as shown in FIG. 1 and FIG. 2 are that the container may be comprised of concrete or of any other sufficiently rigid and strong material such as a polymer, non-corrosive and rustproof metal, and the like or any combinations thereof. The material may be porous or semi-porous. The planter system is partially buried in the ground with the top section of the system exposed to the atmosphere. It is important that the selected construction materials maintain the integrity of the planter system for an extended period of time.

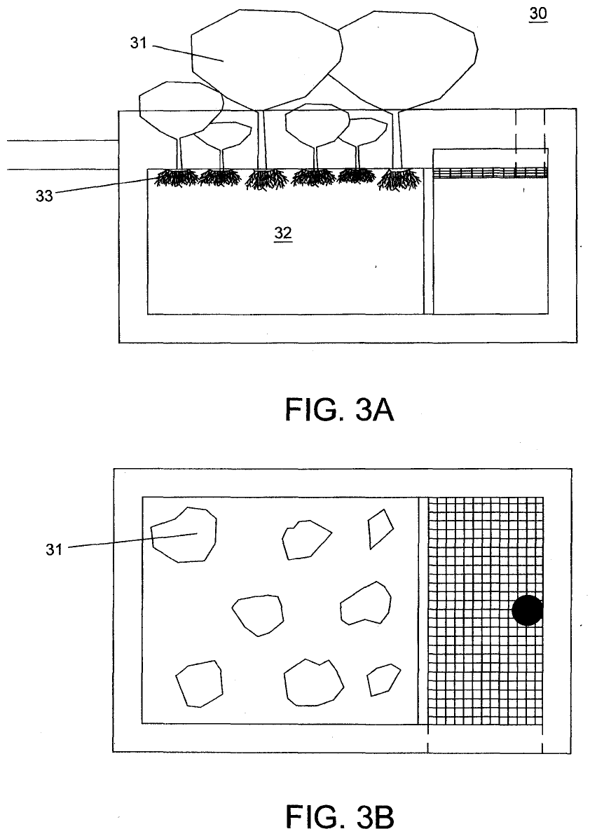

Now referring to FIG. 3A and FIG. 3B of the present invention, an embodiment of the invention would be that the stormwater planter 30 would be comprised of plant material 31 planted directly into an aggregate material 32 within the container whereby the entire plant root system 33 could freely communicate with the aggregate material.

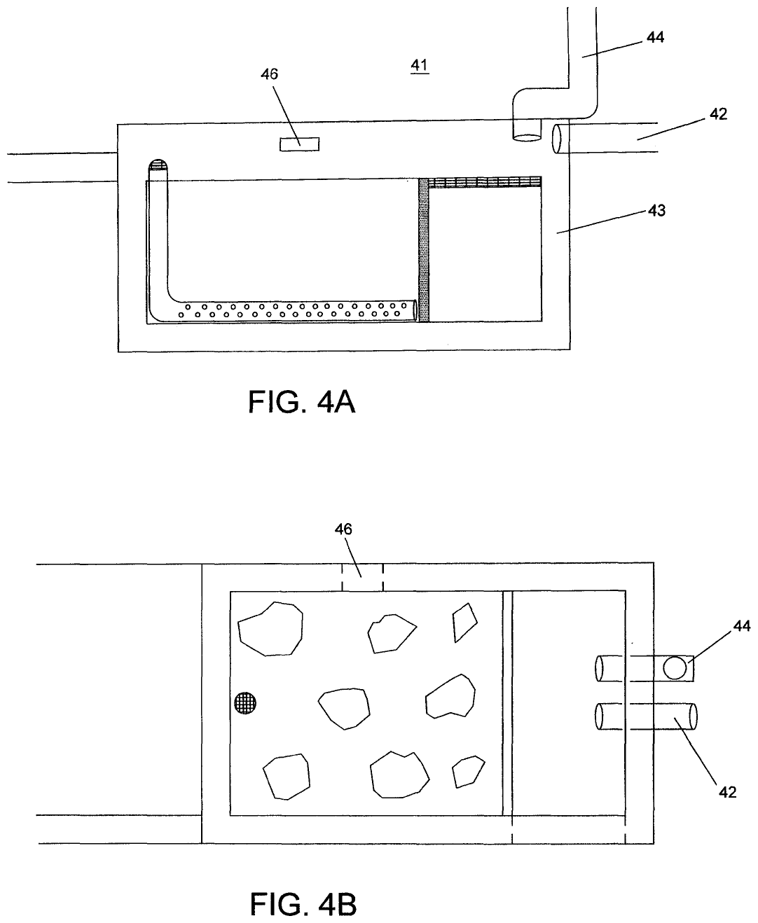

Now referring to FIG. 4A and FIG. 4B of the present invention, an embodiment of the invention would be that the stormwater planter 41 would accept incoming water from one or more pipes 42 originating from exterior of the container and entering through one or more sidewalls 43 of the container. Another embodiment would be that the stormwater planter would accept incoming water from one or more pipes and/or other conduits 44 originating from a point exterior and above the container, such as a building roof or other overhead structure. Incoming pipes and conduits are envisioned to convey water to and/or through the container at predetermined elevations. A further embodiment would be that water may enter the stormwater planter through one or more openings 46 of a predetermined dimension located on one or more sides of the container.

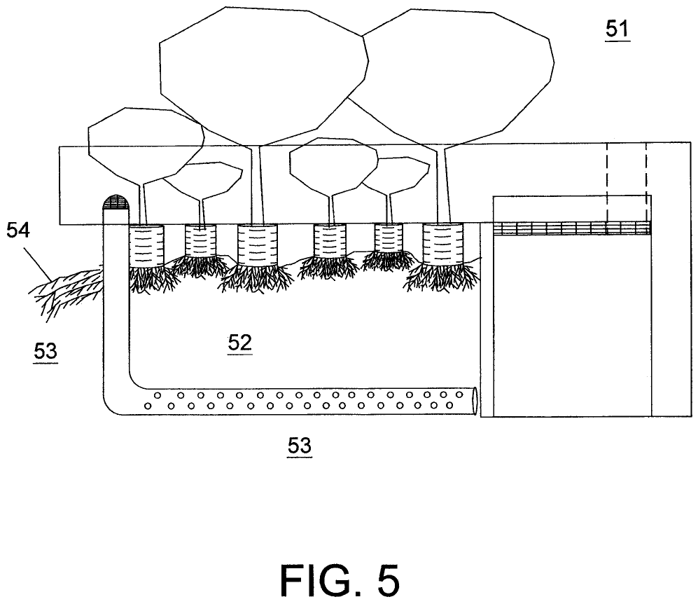

Now referring to FIG. 5 of the present invention, an embodiment of the invention would be that the bottom portion of the stormwater planter 51 which is comprised of an organic and/or in-organic aggregate 52 would be partially or completely open to allow communication between these aggregates and the subsurface environment 53. Furthermore, one or more sides of the container may be partially or fully open to allow communication between the aggregate materials and roots 54 emanating from the interior of the container, and the subsurface environment 53.

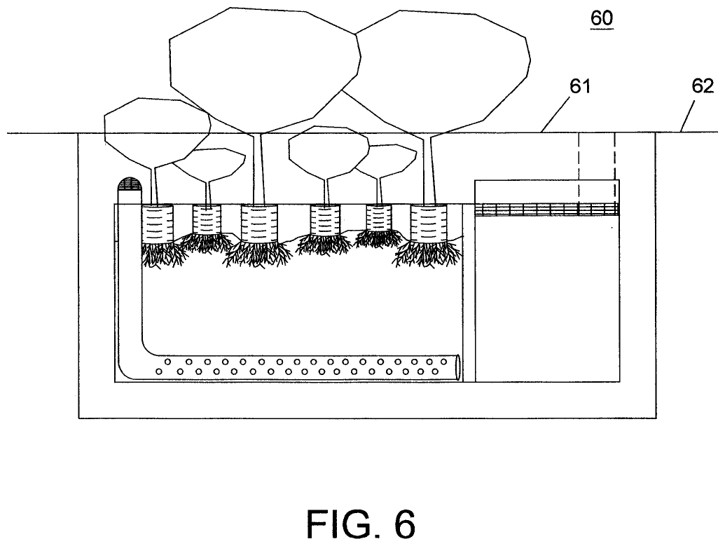

Now referring to FIG. 6 of the present invention, an embodiment of the invention would be that the stormwater planter 60 may be positioned such that the top surface of the container 61 is at equal elevation with its surrounding surface 62.

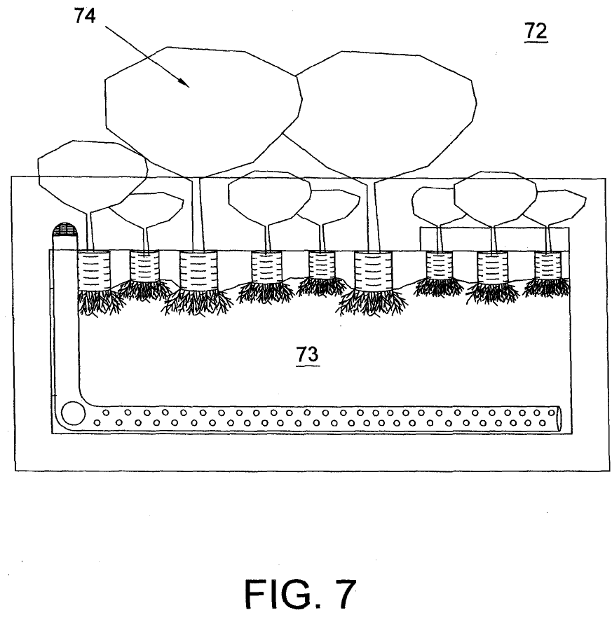

Now referring to FIG. 7 of the present invention, an embodiment of the invention would be that the stormwater planter 72 is not comprised of a separate pretreatment compartment as discussed in FIGS. 1 and 2, and where organic and/or inorganic aggregate material 73 extends to the extremes of all four vertical sidewalls, and the top portion of the container, and that plant material 74 may be located and established within the majority of the interior footprint of the container. The stormwater planter may be comprised of one or more of the embodiments described in FIGS. 3A, 3B, 4A, 4B, 5, and/or FIG. 6.

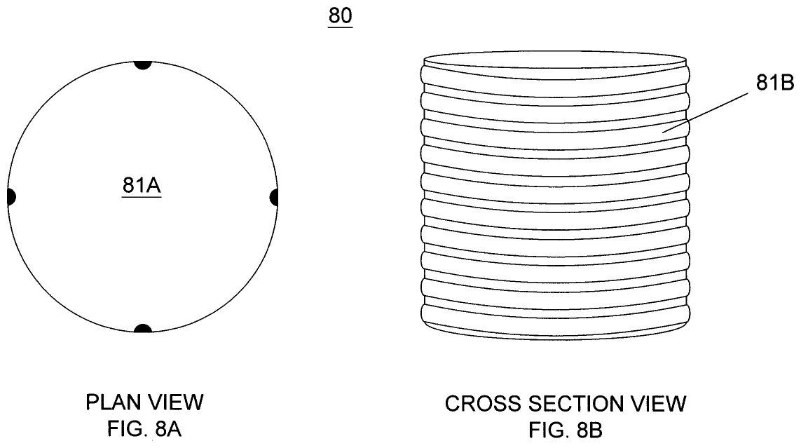

Now referring to FIGS. 8A and 8B of the present invention, an embodiment would be that the primarily open top and open bottomed socket 80 that contains plant material as referenced in FIG.1, would have a surface that is corrugated, ribbed, or otherwise profiled on either the inside 81A, outside 81B, or on both sides of the socket, or otherwise be comprised of ribs on either the interior or exterior side of the socket, or on both sides of the socket. This embodiment would provide beneficial contour to the socket: (1) for the interior, ribs or corrugation disrupts the natural tendency of roots to grow in a horizontal circular pattern once they contact a vertical obstruction, thereby encouraging preferred vertical growth; (2) for the exterior, ribs or corrugation allows for the anchoring of the socket more securely within the organic/non-organic aggregate so as to restrict unintended displacement of the socket, or removal by theft.

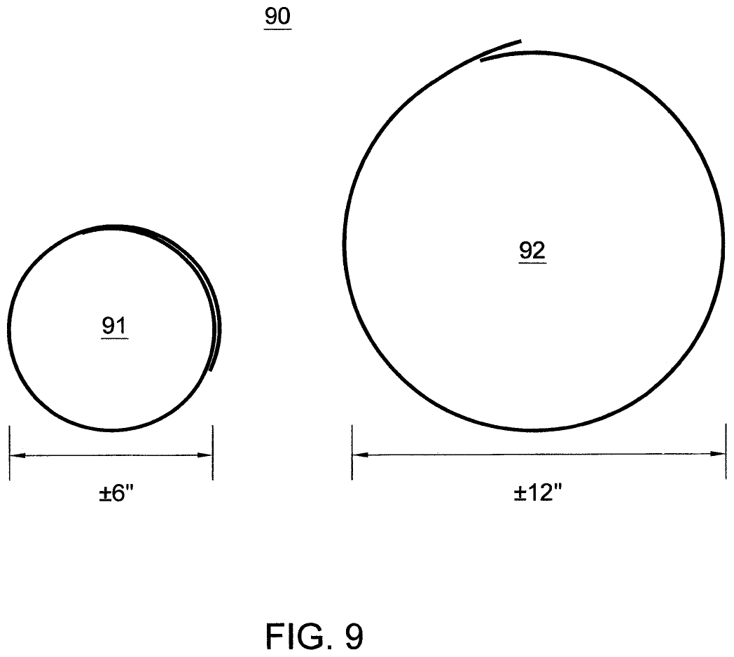

Now referring to FIG. 9 of the present invention, an embodiment would be that the primarily open top and open bottomed socket 90 that contains plant material as referenced in FIG. 1, would not maintain a contiguous, circular sidewall structure, or otherwise maintain the form of a uniform sphere. The socket is envisioned to form the shape of a semi ridged coil that could wind (coiled) 91 or unwind (uncoiled) 92 upon itself, such that it could maintain flexibility in its overall diameter. The interior and/or exterior walls of this socket could be smooth or with corrugation, ribs, or otherwise with a surface contour or other root controlling mechanisms. This embodiment would provide flexibility for the enlargement of the socket as the enclosed plant grows and expands in size. The sockets are designed so that the roots of plant material primarily grow downward and out of the bottom opening of said socket bypassing the inorganic media layer and growing directly into the organic media layer, organic containing trace amounts of inorganic material or the organic and inorganic mixture media layer.

In another embodiment, a flexible impermeable, semi-impermeable or permeable subsurface membrane liner surrounds a substantial portion (or may completely surround the bottom and/or surrounding side walls thereof) of the planter system of FIG. 1. The purpose of this liner would be to provide a barrier between the planter system 2 and media associated with the planter system 2, and that of native or adjoining soils. Inlet and outlet piping of various diameter would be able to penetrate and otherwise traverse the wall of the liner. Such circumstances which may include this embodiment would be if the planter system 2 of the present invention was located proximal to identified sensitive environmental receptors which require protection or segregation. Such examples of these receptors could be water bodies, wetlands, drinking water protection areas and other examples. Another instance when the use of a liner and/or barrier with the system of FIG. 1 would be beneficial, would be when contaminated soil or groundwater was present proximal to the planter system 2, whereby infiltrating water associated with the planter system 2 could potentially co-mingle with, or otherwise contact, contaminated soil or groundwater, thereby spreading the contamination further. A liner and/or barrier with the system of FIG. 1 can be useful in retaining water for future irrigation of the vegetation or preventing unnecessary water from infiltrating and/or entering the tree frame and grate system. The use of a flexible liner would also allow for the expansion of the collection and treatment area beyond the “foot print” of the container; the user therefore would not be constrained by the dimensions of the container, thus allowing for the maximization of the infiltrating media area. The flexible impermeable or semi-impermeable subsurface membrane liner is envisioned to be composed of rubber, polyethylene, or other material(s) either unique or in composite and typically designed to be a barrier to separate one physical area from another physical area. The liner does not have to cover the entire system, may only be situated beneath the planter system 2, and may only cover between 25-95% of the system for various reasons. The system may also incorporate one or more inlet and/or outlet pipes that traverse the liner.

The system of the instant application may be installed into a paved or unpaved surface, but primarily, in a street or sidewalk, or in a commercial parking lot or in front of a commercial or residential establishment. The system may abut a paved surface. Generally, a system is buried in the ground and/or installed into a paved surface to a depth that the top surface of the planter system is flush with the surface of the ground or paved surface. An installed system may be separate from, connected to, in communication with or integrated into street curbing. It may also be raised and/or situated at an elevation above the surface of its surroundings. Aesthetic features, such as benches, chairs, tables, planters, fencing, gates, ornamental decorations, railings, lights, statutes, water features, outdoor sound systems, urns, plaques, bird baths, bird feeders, trash cans and any combinations thereof, may be affixed to or incorporated into the tops of the vertical sidewalls that are exposed to the atmosphere.

It is also envisioned that the present invention also encompasses a second set of sockets permanently installed in the discrete layer of media and that the sockets containing the plant development material fit within these permanently installed second set of sockets. A user would install new, pre-filled sockets into the permanently installed sockets and, when the growing season is over, take the pre-filled sockets out of the permanently installed sockets or when a user is desirous of replacing said sockets and the vegetation contained therein with either new sockets, new vegetation or a combination thereof.

The advantages of the present invention and embodiments include, without limitation, a stormwater planter system comprised of a primarily open or primarily closed sided container to collect rain water emanating from paved surfaces, such as streets, parking lots and sidewalks, and unpaved surfaces, and/or from overhead surfaces. Water could be initially directed to a separate closed bottom pretreatment compartment within the container to separate and collect quantities of sand, sediment, and debris. This compartment could be accessed for the removal of accumulated materials. The water within this compartment would also provide supplemental irrigation and nourishment to plant material located within the container. The present invention and embodiments would provide greater flexibility in the locating of plant material. Based on the design and embodiments, the present invention would provide several advantages in stormwater management and treatment, not least at all to include providing healthier plant establishment and growth; and, reducing the maintenance burden associated with other stormwater planter systems.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods within the scope and spirit of the invention as claimed.

Although the invention has been explained in relation to its preferred embodiment, it is to be understood that many other possible modifications and variations can be made without departing from the spirit and scope of the invention.

I claim:

1. A planter system comprising
at least three vertical sidewalls creating an interior space;
two or more discrete layers of media situated in said interior space;
one or more sockets;
wherein said system is partially buried in the ground;
wherein said sockets are capable of containing media in which to promote vegetation growth; and
further wherein said interior space is exposed to the atmosphere.

2. The planter system according to claim 1, further comprising a fourth vertical sidewall and a full or partial bottom side wall wherein said vertical side walls and full or partial bottom side wall forming an interior space.

3. The planter system according to claim 1 or 2, further comprises a liner situated beneath and/or surrounding said side walls.

4. The planter system according to claim 3, wherein said liner is impermeable, semi-impermeable or permeable.

5. The planter system according to claim 1, wherein said socket is cylindrical in shape and has a primarily open distal end and a primarily open proximal end.

6. The planter system according to claim 5, wherein said socket contains one or more root controlling mechanisms.

7. The planter system according to claim 6, wherein said socket is corrugated or has a profile.

8. The planter system according to claim 7, wherein said profile is one or more outward and/or one or more inward protrusions.

9. The planter system according to claim 8, wherein said protrusions are outward facing ribs and further wherein said ribs anchor said socket securely within the discrete layers of material so as to prevent the unintended displacement or removal by theft of said socket.

10. The planter system according to claim 8, wherein said protrusions are inward facing ribs that act as root control mechanisms.

11. The planter system according to claim 9, wherein said socket is expandable.

12. The planter system according to claim 11, wherein said socket is formed from one or more sheets of material.

13. The planter system according to claim 12, wherein said socket is formed from one sheet of material.

14. The planter system according to claim 12 or 13, wherein said sheet or sheets are flexible.

15. The planter system according to claim 14, wherein said sheets are rolled into a cylindrical shape creating an interior space.

16. The planter system according to claim 15, wherein said flexible sheets have a distal edge and a proximal edge.

17. The planter system according to claim 16, wherein the distal edge of said flexible sheet is situated underneath said proximal edge of said flexible sheet when said flexible sheet is rolled into said cylindrical shape, said socket can expand, increasing said interior space.

18. The planter system according to claim 12, wherein said flexible sheets are formed from a material selected from the group consisting of metal, plastic, liquid silicone rubber, fiberglass and any combinations thereof.

19. The planter system according to claim 18, wherein said plastic is selected from the group consisting of poly(methyl methacrylate), polycarbonate, high-density polyethylene, acrylic-polyvinyl chloride, acrylonitrile butadiene styrene and any combinations thereof or said metal is aluminum.

20. The planter system according to claim 5, wherein said socket can expand its width up to twice its initial size or greater.

21. The planter system according to claim 20, wherein said socket has an initial width of 6±5% inches that can expand up to and including 12±5% inches, has an initial width of 10±5% inches that can expand up to and including 20±5% inches or an initial width of 18±5%) inches that can expand up to and including 36±5% inches.

22. The planter system according to claim 20, wherein said socket has a length of 4±5% inches to 16±5% inches.

23. The planter system according to claim 15, wherein the flexible sheet may be solid or may contain a multitude of perforations.

24. The planter system according to claim 1, wherein said two or more discrete layers of media situated in said interior space include an inorganic, an organic layer, a layer of mixed organic and inorganic material, a layer of inorganic material with trace amounts of organic material or a layer of organic material with trace amounts of inorganic material.

25. The planter system according to claim 24, wherein said inorganic layer is situated above said organic layer, said organic layer with trace amounts of inorganic material or said layer of mixed organic and inorganic material.

26. The planter system according to claim 25, wherein said inorganic layer is comprised of an aggregate media.

27. The planter system according to claim 26, wherein said aggregate media is comprised of materials selected from the group consisting of sand, gravel, stone, rubber, plastic, silica, glass beads, ceramics, shale, clay, activated alumina, activated iron, activated plant-based carbon material, reconstituted rock or the like and any combination thereof.

28. The planter system according to claim 27, wherein said inorganic media further comprises an additive comprised of iron or aluminum oxide, an expanded ceramic, or a water treatment residual no greater than 20% (±5%) by volume or any combination thereof.

29. The planter system according to claim 1, wherein said organic, organic with trace amounts of inorganic material or organic and inorganic mixed layer is capable of supporting vegetation.

30. The planter system according to claim 29, wherein said vegetation is selected from the group consisting of bushes, shrubs, ivy, flowers, cacti, succulents, ferns, ornamental grasses, small conifers, small flowering trees and any combination thereof.

31. The planter system according to claim 1, wherein said system further comprises a water collection and drainage pipe.

32. The planter system according to claim 31, wherein said pipe is perforated.

33. The planter system according to claim 32, wherein said pipe is situated substantially within or in contact with the aggregate media layer located within the interior space of the planter system, wherein said perforations in said pipe allow for the ingress of excess water from the interior of the system into said perforated pipe wherein said excess water is expelled out of the system.

34. The planter system according to claim 33, wherein said pipe extends substantially within or in contact with the aggregate media layer from one vertical side wall, through the interior space of the system and partially exits a vertical side wall.

35. The planter system according to claim 1, wherein said vertical side walls optionally contain one or more throats, apertures or openings of a predetermined dimension through which water may enter the interior space of the planter system.

36. The planter system according to claim 1, wherein said one or more vertical walls may extend upward from 0 to 36 inches above the surface of the ground that the planter system is installed.

37. The planter system according to claim 1, wherein said vertical walls may have a length of from about 2 feet to about 15 feet.

38. The planter system according to claim 1, wherein said vertical walls are manufactured from a rigid and strong material selected from the group consisting of concrete, plastic, non-corrosive and rustproof metal, and any combination thereof wherein said material must be able to maintain its integrity after being buried in the ground for extended periods of time.

39. The planter system according to claim 25, wherein said socket extends from at or above the surface of the inorganic layer, through said inorganic layer, and into said organic layer, said organic layer with trace amounts of inorganic material or said mixed organic/inorganic layer.

40. The planter system according to claim 38, wherein said vertical walls are manufactured from a material that may be porous or semi-porous.

41. The planter system according to claim 38, wherein said vertical walls have one or more windows, baffles, apertures, throats or any combination thereof.

42. The planter system according to claim 1, further comprising a sump having at least three vertical walls connected to a bottom wall creating an interior space wherein said sump collects sand, sediment and large objects that settle to the bottom of said sump.

43. The planter system according to claim 42, wherein the sump abuts one of the vertical walls of the planter system.

44. The planter system according to claim 42, wherein the sump and planter system share a vertical wall.

45. The planter system according to claim 43, wherein the wall of the sump that abuts the planter system extends slightly upwards beyond the top of the wall of the planter system that the sump abuts, is equal in height to the wall of the planter system that the sump abuts or is slightly below the wall of the planter system that the sump abuts.

46. The planter system according to claim 43, wherein one of the vertical walls of the planter system is replaced with a flat panel or baffle wall.

47. The planter system according to claim 46, wherein said flat panel or baffle wall forms a barrier between the planter system and the sump.

48. The planter system according to claim 47, wherein said flat panel or baffle wall is impermeable or semi-impermeable.

49. The planter system according to claim 48, wherein said flat panel or baffle wall is fixed in place upon installation of said system or may be capable of being removed.

50. The planter system according to claim 46, wherein said flat panel or baffle wall is manufactured from a material selected from the group consisting of concrete, plastic, fiberglass, metal and any combination thereof.

51. The planter system according to claim 50, wherein said flat panel or baffle wall allows for the flow of water between the interior of the planter system and the interior of the sump.

52. The planter system according to claim 51, wherein said flat panel or baffle wall allows for the flow of water collected in said sump into the interior of the planter system when needed to irrigate the vegetation within the planter system.

53. The planter system according to claim 51, wherein said flat panel or baffle wall allows for the flow of excess water from the interior of the planter to the sump to prevent the pooling of water in the interior of the planter system.

54. The planter system according to claim 42, wherein said sump is comprised of four vertical walls.

55. The planter system according to claim 54, wherein said sump does not abut said planter system.

56. The planter system according to claim 55, wherein said sump is connected to said plant system by a remote feed.

57. The planter system according to claim 57, wherein said remote feed is a conduit.

58. The planter system according to claim 52, wherein said conduit is a pipe.

59. The planter system according to claim 57, wherein said pipe is manufactured from a material that does not rust or corrode.

60. The planter system according to claim 42, further comprising a grate or perforated screen situated on top of said sump, wherein said grate covers the opening of the sump preventing objects from entering the interior space of the sump.

61. The planter system according to claim 42, wherein said objects are debris.

62. The planter system according to claim 60, wherein said grate is situated below the surface entry of water entering the planter system.

63. The planter system according to claim 62, wherein said water entering the planter system is stormwater.

64. The planter system according to claim 60, wherein said grate is manufactured from a material selected from the group consisting of plastic, metal, fiberglass, a composite thereof and any combination thereof.

65. The planter system according to claim 42, wherein said sump further comprises either a vertical pipe that extends through the grate and into the interior of the sump or an opening in said grate both of which are capable of allowing an evacuation means into said sump wherein said vertical pipe or opening in said grate allows a user to evacuate debris or other undesirable articles accumulated at the bottom of said sump.

66. The planter system according to claim 65, wherein said sump further comprises means in which to create an air tight seal when said evacuation means is inserted into said vertical pipe or opening in said grate.

67. The planter system according to claim 42, wherein said means in which to create an air tight seal when said evacuation means is inserted into said vertical pipe or opening in said grate is a gasket or a collar.

68. The planter system according to claim 65, wherein said evacuation means is a vacuum.

69. The planter system according to claim 65, wherein said evacuation pipe further comprises a removable cap.

70. The planter system according to claim 69, further comprising a locking means to prevent the unwanted removal of the pipe cap.

71. The planter system according to claim 65, wherein said evacuation pipe may be perforated.

72. The planter system according to claim 65, wherein said evacuation pipe is manufactured from a material selected from the group consisting of plastic, metal, fiberglass, a composite thereof and any combination thereof.

73. The planter system according to claim 71, wherein one end of said evacuation pipe extends upward out of the interior of the sump, through the grate and above the grate so as to allow access to said evacuation pipe by a user.

74. The planter system according to claim 73, wherein the end of said evacuation pipe that extends into the interior of the sump is closed.

75. The planter system according to claim 42, further comprising one or more water ingress pipes or conduits located in one or more vertical sidewalls that allow for the direct flow of water originating from a point exterior to and/or above said system into the interior of the planter system or the interior of the sump.

76. The planter system according to claim 75, wherein said exterior point is the roof of a building, one or more gutters of a building or any other overhead structure.

77. The planter system according to claim 75, wherein said water ingress pipes or conduits is relatively horizontal to the planter system and is situated above or below ground at predetermined elevations relative to the planter system.

78. The planter system according to claim 77, wherein the water ingress pipe is connected to one or more a series of additional pipes which carry water from another source to the water ingress pipe.

79. The planter system according to claim 75, wherein said water ingress pipe is perforated.

80. The planter system according to claim 79, wherein said perforations are located in one or more sections of said water ingress pipe that are in direct communication with the interior of the planter system or the interior of the sump.

81. The planter system according to claim 75, wherein said water ingress pipe is manufactured from a material selected from the group consisting of plastic, metal, fiberglass, a composite thereof and any combination thereof.

82. The planter system according to claim 1, wherein said sockets are pre-filled with nutrient-rich soil and/or moisture retaining material and/or time-release fertilizer to support the growth of vegetation situated within the interior of said sockets.

83. The planter system according to claim 60, further comprising a superficial layer of inorganic, organic or a mixture of inorganic and organic aggregate material overlying the grate or perforated screen.

84. The planter system according to claim 31, wherein said water egress pipe is situated relatively horizontally within the aggregate layer.

85. The planter system according to claim 84, further comprising a vertical pipe wherein said vertical pipe is connected to said horizontal water collection and drainage pipe wherein said vertical pipe captures and evacuates accumulating water rising above the top surface of the organic and inorganic materials layers contained in the planter system.

86. The planter system according to claim 85, further comprising a covering over said vertical pipe wherein said covering prevents debris from entering said pipe.

87. The planter system according to claim 86, wherein said covering is a screen or grate.

88. The planter system according to claim 87, wherein said covering is a grate.

89. The planter system according to claim 88, wherein said grate is an atrium or basket grate.

90. The planter system according to claim 2, wherein said vertical side walls are equal in size and dimension.

91. The planter system according to claim 2, wherein said vertical side walls vary in size and dimension.

92. The planter system according to claim 2, further comprising one or more partial top walls.

93. The planter system according to claim 35, further comprising a perforated screen or grate situated in such a way that when said water enters the planter system through said throat or aperture said water encounters said perforated screen or grate

94. The planter system according to claim 93, further comprising a defined superficial layer of inorganic, organic or a mixture of organic and inorganic aggregate material situated above and/or on said perforated screen or grate.

95. The planter system according to claim 11, wherein said one or more sockets contains soil and/or other material to sustain plant material.

96. The planter system according to claim 95, wherein as said plant material grows, said socket expands outward providing additional room in which said plant material may expand.

97. The planter system according to claim 95, further comprising an additional layer situated below the one or more sockets wherein said additional layer below the one or more sockets comprises engineered media designed to promote vegetation growth.

98. The planter system according to claim 96, wherein the roots of said plant material primarily grow downward and out of the bottom opening of said socket.

99. The planter system according to claim 96, wherein said roots bypass the inorganic media layer and grow directly into the organic media layer, organic containing trace amounts of inorganic material or the organic and inorganic mixture media layer.

100. The planter system according to claim 1, wherein said system is installed into a paved or unpaved surface.

101. The planter system according to claim 100, wherein said paved surface is a street, parking lot or sidewalk.

102. The planter system according to claim 1, wherein said system abuts a paved surface.

103. The planter system according to claim 102, wherein said paved surface is a street, parking lot or sidewalk.

104. The planter system according to claim 1, wherein said system is separate from, connected to, in communication with or integrated into street curbing.

105. The planter system according to claim 1, wherein said planter system is raised and/or situated at an elevation above the surface of its surroundings.

106. The planter system according to claim 1, wherein said planter system has an open bottom which provides for communication between the layers contained in the interior of the system and the subsurface environment.

107. The planter system according to claim 1, wherein one or more of the vertical sidewalls may contain one or more openings to allow for communication between the layers contained in the interior of the system and any vegetation contained therein and the surrounding environment.

108. The planter system according to claim 1, wherein said system is buried in the ground and/or installed into a paved surface to a depth that the top surface of the planter system is flush with the surface of the ground or paved surface.

109. The planter system according to claim 1, further comprising a second set of sockets wherein said second set of sockets are permanently installed in said discrete layer of media and said one or more sockets according to claim 1 fit within said second set of sockets wherein said one or more sockets according to claim 1 may be installed in and taken out of said second set of sockets when a user is desirous of replacing said sockets and the vegetation contained therein with either new sockets, new vegetation or a combination thereof.

110. The planter system according to claim 1, further comprising aesthetic features affixed to or incorporated into the tops of the vertical sidewalls that are exposed to the atmosphere.

111. The planter system according to claim 110, wherein said aesthetic features are selected from the group consisting of benches, chairs, tables, planters, fencing, gates, ornamental decorations, railings, lights, statutes, water features, outdoor sound systems, urns, plaques, bird baths, bird feeders, trash cans and any combinations thereof.
